(19) United States
(12) Patent Application Publication
(10) Pub. No.: US 2013/0108120 A1
(43) Pub. Date: May 2, 2013

(54) DEVICE FOR WEIGHING CHICKS

(71) Applicant: INNOVATEC BV, Zijderveld (NL)

(72) Inventor: Philip Karel Marie-Louise VAN DE LOO, Vianen (NL)

(73) Assignee: INNOVATEC BV, Zijderveld (NL)

(21) Appl. No.: 13/659,322

(22) Filed: Oct. 24, 2012

(30) Foreign Application Priority Data
Oct. 26, 2011 (BE) 2011/624

(51) Int. Cl. G06K 9/78

(52) U.S. Cl. 382/110

(57) ABSTRACT

Device for determining the weight and number of chicks or other poultry, whereby the device contains detection and transport means to guide the chicks past the detection means, whereby the detection means enable an outline of the passing chick to be determined, characterised in that these detection means enable two outlines of the same chick to be determined in at least two different directions, and whereby these detection means are linked to a data processing unit that contains an algorithm to calculate an approximate weight from the combination of two or more outlines of the individual chick that came through the detection means at that time.

The present invention relates to a device for weighing chicks.

More specifically the device is intended for quickly and effectively weighing chicks or other poultry that are reared in large numbers in an industrial poultry farm.

Traditionally chicks are reared in industrial poultry farms for example, whereby a large number of young animals are transported by conveyor belt in a short time span and then have to be sorted according to weight for further sale or for statistical or metric purposes.

Devices are already known that make use of a conveyor belt or other means of transport to send the animals, in this case chicks, through a chute, whereby the chute is equipped with a detection system in the vertical plane for example, consisting of an upright light source at one side of the chute and an upright detector for the light source on the other side of the chute.

The light beam from the light source to the detector is interrupted when a farm animal is in the light path, and this interruption is detected by the detector, which can deduce from this, by means of peripheral equipment, that a chick has passed through the beam.

Linear light sources are also known such as for example a matrix of light emitting diodes (LED's) the beams of which are received by linear matrices of detectors.

As a result not only the transit of a chick can be detected, but also its cross-section in one vertical plane can be deduced such that the outline of a chick can be recomposed.

This outline gives a rough approximation of the weight of the chick, but, because it is only measured in one dimension, such an approximation is not very accurate.

A disadvantage attached to such a device is that the data for one chick are only approximate and that a number of chicks of the same weight can produce different outlines in one plane, which can lead to incorrect measurements.

The purpose of the present invention is to provide a solution to this disadvantage and other disadvantages by providing a device that enables two outlines of the same farm animal to be determined simultaneously, i.e. one outline in the vertical plane and one outline in another plane, preferably the horizontal plane.

To this end the invention concerns a device for determining the weight of chicks or other poultry, whereby the device contains detection and transport means to guide the chicks past the detection means, and whereby the detection means enable an outline of the passing chick to be determined, whereby these detection means enable two outlines of the same chick to be determined in at least two different directions, and whereby these detection means are linked to a data processing unit that contains an algorithm to calculate an approximate weight from the combination of two or more outlines of the individual chick that came through the detection means at that time.

Preferably the outlines are two outlines determined in two directions that are cross and preferably perpendicular to one another.

An advantage attached to a device that enables two outlines to be defined in planes perpendicular to one another is that the combination of the two outlines enables the weight of the chick to be calculated much more accurately.

Another advantage of such a device is that it enables sorting to be done according to weight, volume or size with a much better resolving power than with a device that only determines an outline of the chick in one plane.

Another advantage of such a device is that the weight determination can proceed much more quickly than by weighing the chicks individually on a weighing device, which means that the chicks can be weighed, and if applicable sorted, at a much higher rate, resulting in a substantial cost saving.

Preferably the detection means consist of two linear light sources or series of light sources with two corresponding linear detectors or series of detectors, whereby the light sources can for example consist of a row of light emitting or laser emitting diodes.

An advantage of these detection means is that the matrices of LED's for example enable an image of the outline to be formed with a resolution that depends on the number of LED's that are used.

Another advantage of LED's for example is that these light sources are highly energy-efficient light sources and have a long lifetime, and that their wavelength can be chosen according to the application. For example blue light sources can be used if blue-sensitive detectors are used.

Another advantage of these detection means is that they are able to very quickly pass on the measured outlines to a data processing unit.

It is also possible not to use any light sources at all but only to use infrared (IR) light detectors as a detection means that are sensitive to the IR radiation due to the body temperature of the chick.

For example the detection means may consist of IR sensitive digital cameras, whereby the outline of the chick can be registered on the basis of the IR radiation that the chick radiates itself.

An advantage of these IR sensitive detectors or cameras is that light sources are no longer needed and that the weight measurement and sorting can even be done in the dark.

The detection means can also consist of light sources and digital cameras as detectors, whereby the outline of the chick can be recognised on the digital image via image processing software in the camera itself or in the data processing unit that is linked to the camera.

Preferably the software enables an outline to be composed from an image continually built up over time from successive signals from the detection means, and the various outlines of the chicks to be calculated from this image.

Preferably the measuring frequency of the signals by the detection means is high enough to obtain an outline with sufficient resolution, and to send the weight calculated from these outlines to the sorting device promptly.

Preferably the transport means run in a guide that conveys the chicks one by one past the detection means.

An advantage of such a transport means is that the overlapping of outlines due to chicks passing through the detection means simultaneously is prevented.

The transit rate can be raised to 20 chicks per second for example, without rendering the determination of the outline impossible.

An advantage of this high transit rate is that a large number of chicks can be weighed in a very short time span, and if applicable sorted with regard to number and weight, counted and registered at the same time, which is not possible by hand.

Preferably the device for determining the weight of chicks or poultry is coupled to a sorting device with a number of exits for sorting chicks according to weight, and contains an algorithm that enables the chicks to be guided to a selective exit according to the approximate weight, calculated by the data processing unit or by the sorting device itself.

With the intention of better showing the characteristics of the invention, a preferred embodiment of a device according to the invention is described hereinafter by way of an example, without any limiting nature, with reference to the accompanying drawings, wherein:

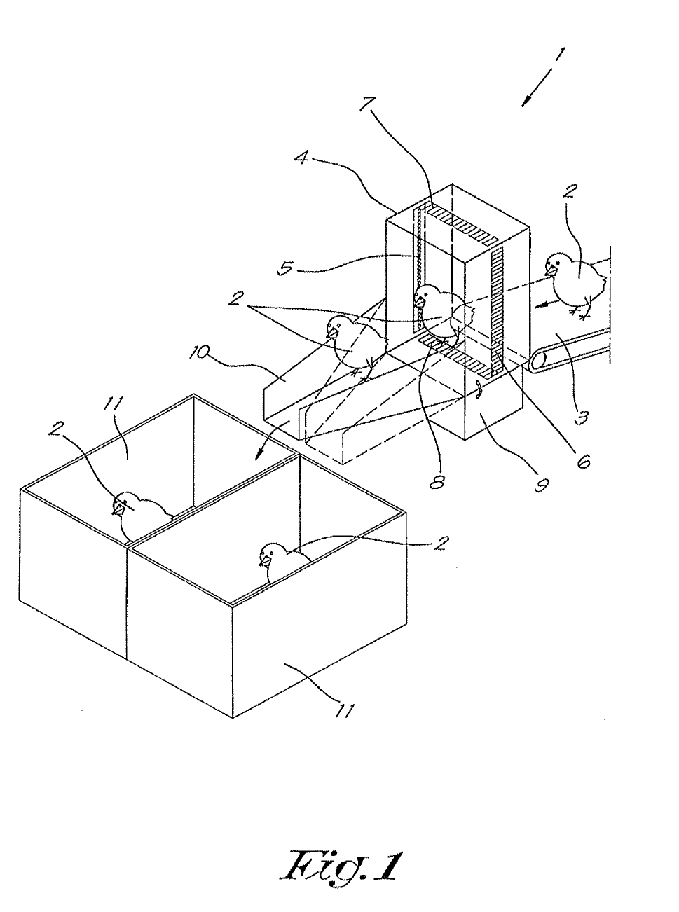

FIG. 1 schematically shows a perspective view of a device for weighing chicks according to the invention;

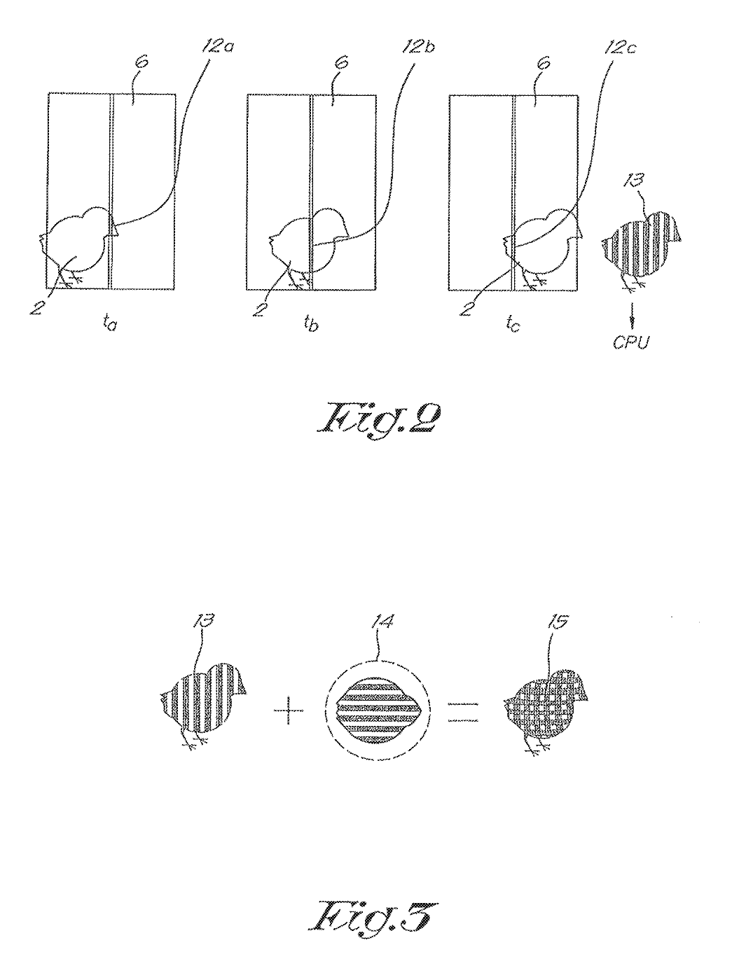

FIG. 2 shows a side view of a first outline of the chick as seen by the detectors from the movement of the chick;

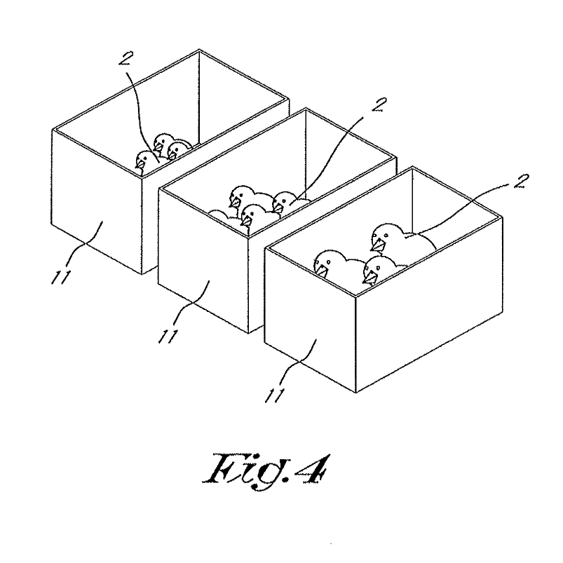

FIG. 3 shows a second outline of the chick measured perpendicular to the first outline and the combination of the two outlines in the vertical and horizontal direction;

FIG. 4 shows a perspective view of the chicks after sorting by weight into different quotas.

FIG. 1 shows the device 1 for weighing chicks 2 according to the invention, whereby chicks 2 are conveyed by a transport means 3 and carried through detection means 4, that consist of a vertical upright linear series of light sources 5 which light beams strike the opposite vertical upright linear series of light detectors 6, and a horizontal linear series of light sources 7 with a linear detector 8 placed opposite thereto. These detection means 4 are connected to a data processing unit 9.

Downstream the detection means 4 are equipped with a movable outlet channel 10 which exit can be directed by the data processing unit 9 to a suitable receptacle 11 for the transported farm animals 2 according to their weight.

The operation of this device 1 is simple and as follows.

Chicks 2 are conveyed at a certain rate up to a number of animals per second by a transport system 3, by which the chicks move through the detection means 4 and pass through a horizontal 8 and vertical detector 6. While the chick 2 passes by the horizontal 7 and vertical 5 linear light sources, the light beam from some of the light sources is no longer detected by the vertical 6 and horizontal detector 8.

The detected signal from both detectors is sent at various points in time during the transit of the farm animal 2 to the data processing unit 9, which recomposes the successive signals into two outlines of the farm animal that has passed through, i.e. a side-view outline 13 and a top-view outline 14.

FIG. 2 shows how the signal 12 for the side view is measured at successive points in time ta, tb, tc, etc, to form corresponding signals 12a, 12b, 12c, that are combined by the data processing unit 9 into a side-view outline 13.

FIG. 3 shows how the signals measured for the top view are combined into a top-view outline 14, which is then combined with the side-view outline 13 to form a recomposed volume 15 of the chick.

By combining the two outlines 13,14 the data processing unit 9 can very quickly calculate the volume and approximate weight of the chick 2, after which the data processing unit 9 sends an appropriate command to the movable outlet 10 so that the exit of this last-mentioned adopts the desired position to let the weighed farm animal land in the receptacle 11 in which its weight category is collected.

It goes without saying that the detection means 4 can also consist of two linear IR detectors 6,7 perpendicular to one another, whereby a light source is not required but the body temperature of the farm animal provides the IR radiation that is received by the detectors.

It also goes without saying that other embodiments are possible to obtain this two dimensional outline measurement, and that for example use can be made of digital cameras as detectors, which signal is converted by image processing into a relevant outline in the camera itself, or in the data processing unit linked to it 9.

It will also be clear that the speed of the signal transfer from the detectors to the data processing unit must be attuned to the speed with which the chicks pass through the detectors, so that these signals can be processed promptly to control the sorting device.

It is also clear that this device can not only be used for sorting, but also for compiling statistics or for other data processing purposes that can be linked to the measurement data.

The present invention is by no means limited to the embodiment described as an example and shown in the drawings, but a device for weighing and/or counting chicks according to the invention can be realised in all kinds of variants, without departing from the scope of the invention.

1. Device for determining the weight and number of chicks or other poultry, whereby the device contains detection and transport means to guide the chicks past the detection means, whereby the detection means enable an outline of the passing chick to be determined, characterised in that these detection means enable two outlines of the same chick to be determined in at least two different directions, and whereby these detection means are linked to a data processing unit that contains an algorithm to calculate an approximate weight from the combination of two or more outlines of the individual chick that came through the detection means at that time.

2. Device according to claim 1, characterised in that the outlines are two outlines determined in two directions that are cross and preferably perpendicular to one another.

3. Device according to claim 1, characterised in that the detection means consist of two linear light sources or series of light sources with two corresponding linear detectors or series of detectors.

4. Device according to claim 3, characterised in that the light sources consist of light emitting or laser emitting diodes (LED's).

5. Device according to claim 1, characterised in that no light sources but only detectors for infrared (IR) light are used as a detection means, that are sensitive to the IR radiation due to the body temperature of the chick.

6. Device according to claim 3, characterised in that the detection means consist of IR-sensitive digital cameras, whereby the outline of the chick can be registered on the basis of the IR radiation that the chick emits itself.

7. Device according to claim 2, characterised in that the detection means consist of light sources and digital cameras as detectors, whereby the outline of the chick on the digital image can be recognised via image processing software in the camera itself or in the data processing unit linked to the detectors.

8. Device according to claim 1, characterised in that the software enables an outline to be composed from an image built up over time from successive signals from the detection means, and on the basis of this image enables the various outlines of the chicks to be calculated.

9. Device according to claim 1, characterised in that the measuring frequency of the signals by the detection means is high enough to obtain an outline with sufficient resolution and to be able to promptly send the weight calculated from these outlines to the sorting device.

10. Device according to claim 1, characterised in that the transport means run in a guide that convey the chicks one by one past the detection means or can be distinguished between by the detection means one by one.

11. Device according to claim 1, characterised in that the transit rate can be raised up to 20 chicks per second for example, without making the determination of the outlines impossible.

12. Sorting device with a number of outputs for sorting chicks, characterised in that it comprises a device according to any one of the previous claims and an algorithm that enables the chicks to be counted, registered, weighed and if applicable sorted by guiding them to a selective exit of a sorting device according to the approximate weight, calculated by the data processing unit or by the sorting device itself.
